(19) United States
(12) Patent Application Publication
(10) Pub. No.: US 2008/0143502 A1
(43) Pub. Date: Jun. 19, 2008

(54) Performance automotive electronic traction indicating device

(76) Inventors: Ralph Stanley Borden, Cottonwood, CA (US); Daniel David Caris, Catheys Valley, CA (US)

Correspondence Address: Ralph Stanley Borden;Daniel David Caris, P.O. Box 1030, Cottonwood, CA, 96022, US

(21) Appl. No.: 11/638,729

(22) Filed: Dec. 13, 2006

(51) Int. Cl. G08B 23/00

(52) U.S. Cl. 340/438; 180/197

(57) ABSTRACT

The present invention allows for the Performance Automotive Electronic Traction Indicating Device to be mounted in any performance vehicle, in any location within the vehicle or moved to another vehicle with ease. The Performance Automotive Electronic Traction Indicating Device allows for the driver to pre-set the percentage difference of rotation or travel between the driven wheel and the un-driven wheel or driving surface to suit varying conditions. The present invention allows for the driver to calibrate the device easily while on the race track without it being a distraction to the driver. The present invention allows for the Performance Automotive Electronic Traction Indicating Device to store output data for later review. The present invention allows for the Performance Automotive Electronic Traction Indicating Device to transmit data to a data receiving device for real time review of the incoming data. The present invention allows for the Performance Automotive Electronic Traction Indicating Device to indicate to the driver through sensory inputs of visual, audio, and tactile the sequentially increasing level of slippage or over-rotation on the driving surface the driven tire or tires are experiencing.

### FEDERALLY SPONSORED RESEARCH

Not Applicable

### SEQUENCE LISTING OR PROGRAM

Not Applicable

### BACKGROUND

1. Field of Invention

This invention relates to Traction Indicators specifically, Performance Automotive Electronic Traction Indicators.

2. Description of the Prior Art

Current methods used to prevent high performance automobiles from losing drive wheel traction has been achieved by either manually sensing the loss of traction by the feel of the vehicle becoming unstable and or by the sound of the engine over revving, or by the use of a traction controlling devices such as U.S. Pat. No. 6,037,862 issued to Ying on Mar. 14, 2000 that interfaces the wheel rotation with the travel speed. The practice of manually sensing wheel spin, while used widely in the racing industry, requires years off development to perfect, and many drivers never do achieve an acceptable development of this skill because of the inability to relate to the relationship between loss of traction and the actual feel of this occurrence. The use of traction controlling devices, while effective, is very expensive and in many sanctioning bodies of the different racing organizations they are illegal to use or, to even have them in the vehicle. While other traction warning devices do just that, warn that traction has been lost but not sequentially, from a pre-determined minimum to a pre-determined maximum that is controllable by the driver.

### OBJECTS AND ADVANTAGES

Accordingly, several objects and advantages of this invention are:
a. To provide a traction indicating device.
b. To provide a traction indicating device that is inexpensive.
c. To provide a traction indicating device that can be mounted easily on different types of vehicles.
d. To provide a traction indicating device that can calibrate easily the circumference difference between the driven tires and the un-driven tires or the ground speed of the vehicle.
e. To provide a traction indicating device that can be easily adjusted by the driver.
f. To provide a traction indicating device that can be manufactured from readily available materials.
g. To provide a traction indicating device that can be mass produced using current manufacturing procedures.
h. To provide a traction indicating device that teaches the driver the feel of the vehicle loosing traction.
i. To provide a traction indicating device that supplies multiple sensory inputs to the driver.
j. To provide a traction indicating device that provides a auditory signal that increases the sound level and the frequency of recurrence of the auditory signal as level of slippage increases.
k. To provide a traction indicating device that provides a visual signal that indicates the percentage of slippage through a series of LED lights with colors that progress to different colors and levels of color as the level of slippage increases.
l. To provide a traction indicating device that provides sensory vibration on the persons body that indicates the percentage of slippage by increasing the intensity and frequency of the vibration as the loss of traction increases.
m. To provide a traction indicating device that records all the output information to review at a later time.
n. To provide a traction indicating device that transmits output traction data information through a wireless connection.
o. To provide a traction indicating device that can has an adjustment allowing the driver to easily adjust the indication of the percentage of slippage or loss of traction of the driven tire or tires on the driving surface.

### SUMMARY OF INVENTION

The present invention relates to the Traction Indicating Device now present in the prior art, it provides an improved Traction Sensing Device. The present invention allows for the Performance Automotive Electronic Traction Indicating Device to be mounted in any vehicle, in any location within the vehicle or moved to another vehicle with ease. The present invention allows for the driver to pre-set the percentage difference of rotation between the driven wheel and the un-driven wheel or driving surface to suit varying traction conditions. The present invention allows for the Performance Automotive Electronic Traction Indicating Device to calibrate the device easily while on the race track without it being a distraction to the driver. The present invention allows for the Performance Automotive Electronic Traction Indicating Device to store output data for later review. The present invention allows for the Performance Automotive Electronic Traction Indicating Device to transmit data to a data receiving device for real time review of the incoming traction data. The present invention allows for the Performance Automotive Electronic Traction Indicating Device to indicate to the driver through sensory input the level of slippage or over-rotation the driven tire is experiencing.

The present invention allows for the Performance Automotive Electronic Traction Indicating Device to act as a teaching aid for learning driver control of the vehicle traction.

### DRAWING FIGURES

FIG. 1 shows a plan view of a motor vehicle depiction with the Traction Indicating Device

FIG. 2 Shows a block diagram of the electronic components of the Performance Automotive Electronic Traction Indicating Device.

### REFERENCE NUMERALS IN DRAWINGS

2 Motor vehicle representation.
3 Driving surface.
4 Engine.
6 Transmission.
8 Differential.
10 Automobile transmission to differential drive shaft.
12a Un-driven right side tire.
12b Un-driven left side tire.
14a Driven right side tire.
14b Driven left side tire.
22a Rotation sensor for un-driven tire or driving surface.
22b Rotation sensor for driven tire.
24 Performance Automotive Electronic Traction Indicating Device
26 Automobile battery.
28 Traction indicating output sensing device.
32 Automobile engine ignition distributor.
34 Traction indicating device calibration control.
36 Traction indicating LED light display.
38 Percentage ratio control knob.
40 Data input/output module.
42 Data transceiver.
44 Display output module.
46 Sensitivity Scaler.
48 Calibrator.
50 Sensor input conditioner.
52 Clock Timer.

### DETAILED DESCRIPTION

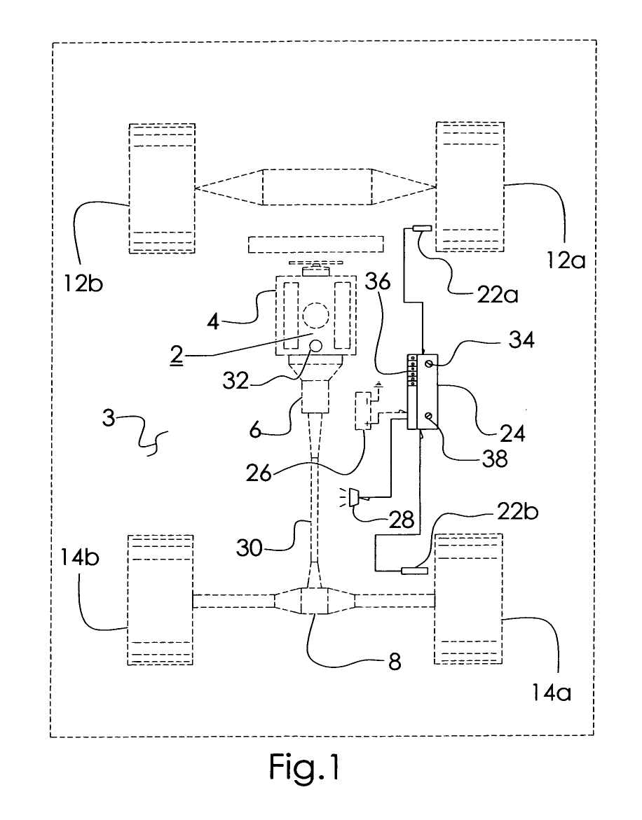

### DESCRIPTION—FIG. 1

The following detailed description is directed to the presently contemplated mode of carrying out the invention. This description is not intended to be limitative, but be made solely for the purpose of illustrating the general principles of the invention. The various features and advantages of the present invention may be more readily understood with reference to the following detailed description, taken in conjunction with the accompanying drawing like numbers refer to the same feature or part thereof.

The preferred embodiment of the Performance Automotive Electronic Traction Indicating Device 24 of the present invention is illustrated in FIG. 1, a plan view of the Motor vehicle representation 2 setting upon a Driving surface 3 with the Performance Automotive Electronic Traction Indicating Device 24 attached to the Motor vehicle representation 2. While the Driven Right Side Tire 14a turns, the Rotation Sensor for the driven tire 22b picks up that rotations and signals back to the Performance Automotive Electronic Traction Indicating Device 24 where it is processed by the Performance Automotive Electronic Traction Indicating Device 24. This can also be completed if the rotation sensor for the driven tire was moved over to the Driven tire left side 14b or positioned next to the Automobile transmission to differential drive shaft 10. When the Un-driven right side tire 12a or the un-driven left side tire 12b turns, the Rotation sensor for the un-driven tire 22a senses the rotations of the un-driven right side tire 12a or the un-driven left side tire 12b and signals back to the Performance Automotive Electronic Traction Indicating Device 24 where it is processed by the traction indicating device. Power for the Performance Automotive Electronic Traction Indicating Device 24 is supplied by the automobile battery 26. Performance Automotive Electronic Traction Indicating Device 24 is turned on and calibrated with the Traction indicating device control knob 34 and the percentage ratio control knob 38 controls the amount of slip differential between un-driven right side tire 12a and the driven right side tire 14a. The Traction indicating LED display 36 Will light and sequentially advance as the level traction slippage increases. Traction indicating output sensing device 28 will indicate in an increasingly expanding frequency and intensity as the level traction slippage increases.

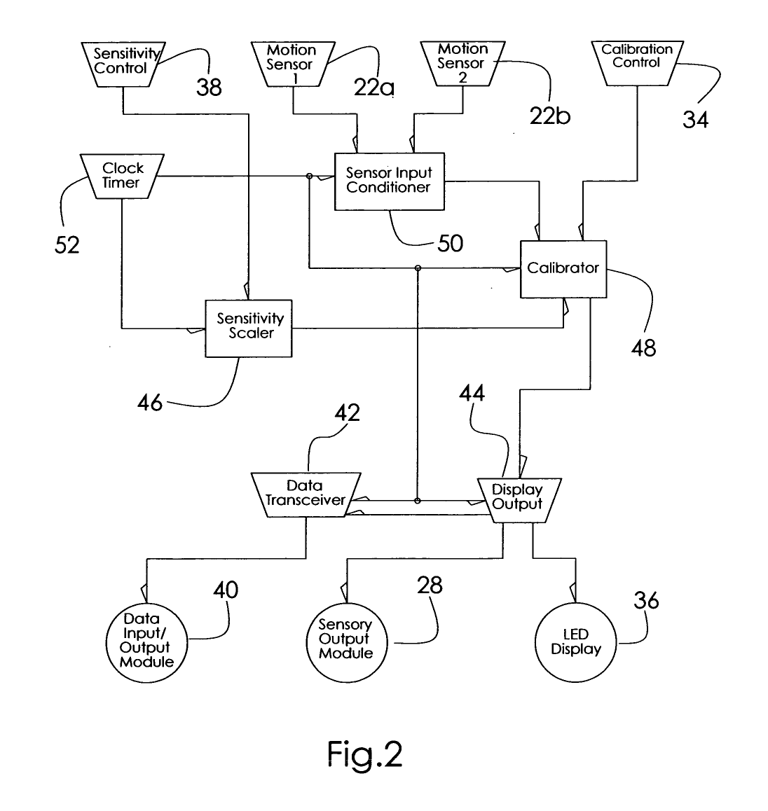

### DESCRIPTION—FIG. 2

The preferred embodiment of the Performance Automotive Electronic Traction Indicating Device 24 of the present invention is illustrated in FIG. 2, a block diagram of the Performance Automotive Electronic Traction Indicating Device 24 operating components. Motion sensor 22a and 22b connected to the Sensor Input Conditioner 50. The clock Timer 52 is circuited to the Sensor Input Conditioner 50 as well as the Sensitivity Scaler 46 and is also circuited to the Calibrator 48. The Sensitivity Control 38 is also connected to the sensitivity Scaler 46. The Calibration Control 34 is also connected to the Calibrator 48. The Display Output 44 and the Data Transceiver 42 are connected and circuited from the clock timer 52 circuit. The Display Output device 44 is also circuited to the Data Transceiver 42 which is circuited to the Data Input/Output Module 40. The Display Output 44 is also circuited to the LED Display 36 an also circuited the Sensory output device 28

### OPERATION OF INVENTION

The preferred embodiment of the Traction Indicating Device 24 of the present invention is illustrated in FIG. 1 a plan view of the Motor vehicle representation 2 with the Traction Indicating device 24 attached. While the driven right side tire 14a turns, the rotation sensor for the driven tire 22b picks up that rotation and signals back to the Performance Automotive Electronic Traction Indicating Device 24 where it is processed by the Performance Automotive Electronic Traction Indicating Device 24. This can also be completed if the rotation sensor for the driven tire was moved over to the Driven tire left side 14b or positioned next to the automotive transmission to differential drive shaft 10. Whenever the vehicle is moving and the Tires 14a, 14b, 12a, and 12b are turning, the Rotation sensor for the un-driven right side tire 22a senses the rotation of the Un-driven right side tire 12a or the rotation of the Un-driven left side tire 12b and the Rotation sensor for the driven tire 22b senses rotations of the Driven right side tire 14a or Driven left side tire 14b, they sends pulses to the Performance Automotive Electronic Traction Indicating Device 24. When the un-driven right side tire 12a or the un-driven left side tire 12b turns, the rotation sensor for the un-driven tire 22a picks up the rotation of the un-driven right side tire 12a or the un-driven left side tire 12b and signals back to the traction indicating device 24 where it is processed by the Performance Automotive Electronic Traction Indicating Device 24. When the Driven right side tire 14a or the Driven left side tire 14b exceed the traction coefficient between the Driving surface 3 and the Driven right side tire 14a and or the driven left side tire 14b the increasing rotation speed of the Driven right side tire 14a or the Driven left side tire 14b increases the pulses picked up by the Rotation sensor for the driven tire 22b. The differential between the calibrated pulses of the Rotation sensor for the un-driven tire 22a and the Rotation sensor for the driven tire 22b is processed by the Performance Automotive Electronic Traction Indicating Device 24 which signals the Traction indicating LED display 36 to begin sequentially activating the LED emitters corresponding with the increasing loss of traction and simultaneously activating the Sensory output device 28 increasing it's intensity and frequency coinciding with the increasing loss of traction coefficient between the Driving surface 3 and the Driven right side tire 14a and or the driven left side tire 14b. While the Performance Automotive Electronic Traction Indicating Device 24 processes the data provided by the input sensors and sends the data to the Data input/output module 40 and stores that data in a memory card for later review. That data can also be transmitted over a wireless communication device and viewed on a laptop computer with real time data. This would be a very valuable tool for team managers to monitor driver and vehicle performance. Power for the Performance Automotive Electronic Traction Indicating Device 24 is supplied by the automobile battery 26. Performance Automotive Electronic Traction Indicating Device 24 is turned on and calibrated with the traction indicating device control knob 34 and the percentage ratio control knob 38 controls the amount of slip differential between un-driven right side tire 12a and the driven right side tire 14a.

### CONCLUSIONS, RAMIFICATIONS and SCOPE

Accordingly, the reader will see that the Performance Automotive Electronic Traction Indicating Device of this invention can be used conveniently, inexpensively and can be set up easily.

It can be made of different materials.

It can be made of using different dimensions, such as, making it taller, shorter, wider, narrower, lighter, heavier, or in whatever configurations not stated.

It allows for an easy and quick setup in performance vehicles.

Although the description above contains much specificity, these should not be construed as limiting the scope of the invention, but as merely providing illustrations of some of the presently preferred embodiments of this invention. For example, it may be set up in a training situation not utilizing the vehicle but, in a vehicle simulator, thus, the scope of the invention should be determined by the appended claims and their legal equivalents, rather than by the examples given.

1. A method for sensing percentage of driving traction loss between the driven wheel of a motor vehicle and the driven surface the said vehicle is traveling upon, comprising of:
a. motion sensor sensing the circumferential travel of the driven wheel;
b. motion sensor sensing the circumferential travel of the un-driven wheel;
c. micro processing device processing input data received from said motion sensor sensing the said circumferential travel of the said driven wheel along with the said motion sensor sensing the said circumferential travel of the un-driven wheel;
d. visual light emitting device indicating sequentially said percentage loss of said traction between said driven wheel of said motor vehicle and said driven surface said vehicle is traveling upon;
e. audio device indicating sequentially said percentage loss of said traction between said driven wheel of said motor vehicle and said driven surface said vehicle is traveling upon;
f. tactile device indicating sequentially said percentage loss of said traction between said driven wheel of said motor vehicle and said driven surface said vehicle is traveling upon.

2. A method for controlling the percentage of driving traction loss between the driven wheel of a motor vehicle and the driven surface the said vehicle is traveling upon as described in claim 1, further comprising of the sensitivity control device controlling said percentage of said driving traction loss between said driven wheel of a said motor vehicle and said driven surface said vehicle is traveling upon.

3. A method for calibrating the difference of said circumferential travel of the un-driven wheel relating to said circumferential travel of the driven wheel by means of the calibrator device of said micro processing device activated by the calibration control of said micro processing device as described in claim 1.

4. A method of storing data in a data storage device generated by said micro processing device processing input data as described in claim 1 to be viewed at a later time.

5. A method of transmitting data generated by said micro processing device as described in claim 1 to a remote data collection device for real time data collection and viewing.
